(19) United States
(12) Patent Application Publication
(10) Pub. No.: US 2022/0329502 A1
(43) Pub. Date: Oct. 13, 2022

(54) NOTIFYING SERVICE PROVIDER OF WI-FI GATEWAY ISSUES

(71) Applicant: ARRIS Enterprises LLC, Suwanee, GA (US)

(72) Inventors: Aniket SALUNKHE, Thane (IN); Aravind VENUGOPAL, Bangalore (IN); Rajat GHOSH, Bangalore (IN)

(21) Appl. No.: 17/705,561

(22) Filed: Mar. 28, 2022

Related U.S. Application Data
(60) Provisional application No. 63/174,407, filed on Apr. 13, 2021.

(51) Int. Cl. H04L 41/5074; H04W 24/04

(52) U.S. Cl. CPC H04L 41/5074; H04W 24/04; H04W 84/12

(57) ABSTRACT

Methods and systems of notifying a service provider regarding Wi-Fi gateway issues are shown and disclosed. In one embodiment, the method includes detecting, via a Wi-Fi gateway, an issue related to the Wi-Fi gateway, and embedding, via the Wi-Fi gateway, information related to the detected issue in an IEEE 802.11 management frame. The method additionally includes broadcasting, via the Wi-Fi gateway, the IEEE 802.11 management frame with the embedded information, and receiving, via an application running on a Wi-Fi device, the IEEE 802.11 management frame with the embedded information. The method further includes transmitting, via the application running on the Wi-Fi device, the embedded information to the service provider.

### CROSS REFERENCE TO RELATED APPLICATIONS

None

### BACKGROUND

The subject matter of this application relates to notifying service providers of Wi-Fi gateway issues, in particular systems and methods of notifying service providers of Wi-Fi gateway issues via associated or non-associated Wi-Fi devices, such as smart phones, tables, and/or desktop computers.

Generally, an end user is unaware of issues with a Wi-Fi gateway (e.g., residential gateway) until he or she tries to access, for example, the Internet, through the Wi-Fi gateway. Once there is an access issue, it generally is not straightforward for the end user to identify or detect the specific issue with the Wi-Fi gateway to allow the end user to notify the service provider of that issue. Instead, the end user must contact a customer service representative of the service provider. The customer service representative must then go through a time-consuming troubleshooting process with the end user to identify the specific issue, identify steps that will resolve that issue, and perform those steps.

What is desired, therefore, are systems and/or methods that notify service providers of Wi-Fi gateway issues while eliminating or minimizing the need for end users to be involved in the troubleshooting process.

### BRIEF DESCRIPTION OF THE DRAWINGS

For a better understanding of the invention, and to show how the same may be carried into effect, reference will now be made, by way of example, to the accompanying drawings, in which:

FIG. 1 is a high-level block diagram of an example of a network to facilitate notifying the service provider of Wi-Fi gateway issues.

FIG. 2 is a flowchart illustrating an example process of notifying the service provider of Wi-Fi gateway issues.

FIGS. 3A-3B are block diagrams of an example of a beacon frame with embedded issue information.

FIG. 4 is a block diagram of an example of a hardware configuration operable to facilitate notifying the service provider of Wi-Fi gateway issues.

### DETAILED DESCRIPTION

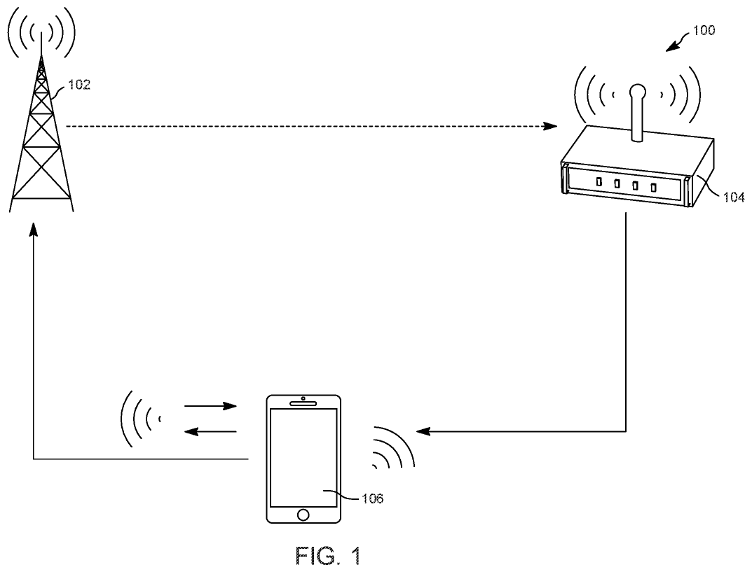

Referring to FIG. 1, an example network environment 100 for notifying a service provider 102 of issues related to a Wi-Fi gateway 104 via one or more Wi-Fi devices 106. Service provider 102 may include one or more Multiple System Operator (MSO) systems having one or more headends, regional headends, a network architecture of fiber optic, twisted pair, and/or co-axial lines, and/or amplifiers. Service provider 102 may additionally, or alternatively, include one or more Internet Service Providers (ISPs) having a Point of Presence (POP) that connect to Network Access Points (NAP), such as via routers and a T3 backbone. Wi-Fi gateway 104 includes any gateway and/or networking hardware device that provide one or more Wi-Fi access points to Wi-Fi devices 106 via a wired connection to, for example, a router. In other words, Wi-Fi gateway 104 allows Wi-Fi devices 106 to connect to a wired network. Wi-Fi devices 106 include desktop computers, smart phones, tablet computers, smart watches and other wearables, gaming systems, etc. The Wi-Fi devices may have a graphic user interface (GUI) that may be accessed by the user via the screen of the device. Wi-Fi devices 106 also may connect to, for example, the Internet via one or more cellular signals. The Wi-Fi devices 106 include an application 108 for notifying service provider 102 of issues related to Wi-Fi gateway 104.

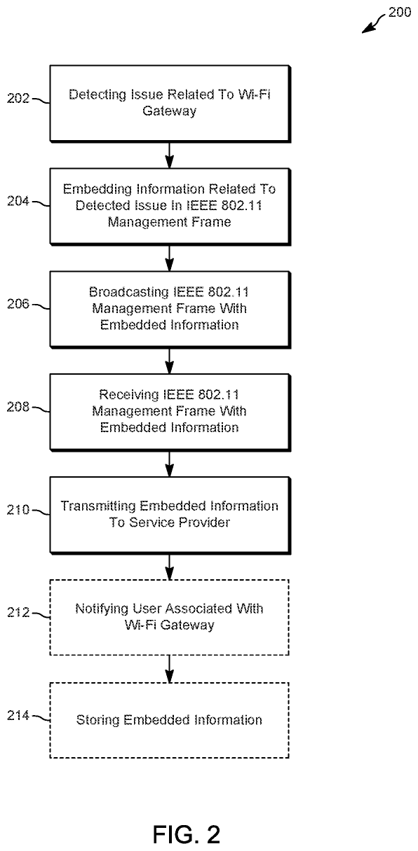

Referring to FIG. 2, a flowchart is shown of an example method or process 200 of notifying the service provider of Wi-Fi gateway issues, which may be performed, for example, by Wi-Fi gateway 104 and/or Wi-Fi devices 106. At 202, an issue related to the Wi-Fi gateway is detected by the Wi-Fi gateway. For example, the Wi-Fi gateway may detect one or more connectivity issues, such as the inability to communicate with the service provider because of power loss, connection loss, etc. The Wi-Fi gateway may sense the issue and identify its source using available driver interfaces. Additionally, the Wi-Fi gateway may store the obtained information in one or more logs. Particularly with connectivity issues, the Wi-Fi gateway can detect an issue, identify its source, and/or store information regarding the issue and source but may be unable to provide that information to the service provider.

At 204, information related to the detected issue is embedded by the Wi-Fi gateway in, for example, an IEEE 802.11 management frame, such as in a beacon frame. In some embodiments, the information related to the detected issue may be encrypted prior to embedding of the information in the management frame, and that encrypted information is embedded in the management frame. The information may be any information related to the Wi-Fi gateway issue, such as information regarding diagnosis, cause(s), solution(s), etc.

At 206, the IEEE 802.11 management frame is broadcasted by the Wi-Fi gateway. The IEEE 802.11 management frame may be transmitted periodically to all nearby associated and non-associated Wi-Fi devices to announce the presence of a wireless Local Area Network (LAN) and to synchronize the members of a service set. When the management frame is a beacon frame, the beacon frame may be transmitted by the Wi-Fi gateway in an infrastructure basic service set (BSS). An example of a beacon frame is further discussed below.

At 208, the IEEE 802.11 management frame with the embedded information is received via an application running on a Wi-Fi device. The Wi-Fi device may be connected to or associated with the Wi-Fi gateway that broadcasted the IEEE 802.11 management frame. Alternatively, the Wi-Fi device may be not connected to or not associated with that Wi-Fi gateway.

At 210, the embedded information is transmitted to the service provider via an application running on the Wi-Fi device. The transmission may occur via an access point different from the Wi-Fi gateway, such as a different gateway or access point. Alternatively, or additionally, the transmission may occur via one or more cellular signals (e.g., 3G, 4G, 5G, etc.). In some embodiments, transmitting includes extracting the embedded information from the received IEEE 802.11 management frame via an application running on the Wi-Fi device. The extraction may be performed only on beacon frames of the particular Wi-Fi gateway and not on beacon frames of other Wi-Fi gateways. For example, the application may first determine if the beacon frame is from the particular Wi-Fi gateway associated with the Wi-Fi device and/or a user of the Wi-Fi device, and then extract and/or transmit embedded information from only beacon frames received from the particular Wi-Fi gateway associated with the Wi-Fi device and/or the user of the Wi-Fi device. The application in step 210 may be the same application or a different application from step 208.

Method 200 may, in some embodiments, include, at 212, notifying a user associated with the Wi-Fi gateway via an application running on the Wi-Fi device. For example, the application may provide a banner, a pop-up window, a badge via the display screen of the Wi-Fi device and/or may generate one or more sounds via the speaker of the Wi-Fi device. The application in step 212 may be the same or different from the application in steps 208 and/or 210. Method 200 may, in some embodiments, include, at 214, storing the embedded information via an application running on the Wi-Fi device. The application in step 214 may be the same or different from the application in steps 208, 210, and/or 212. Although FIG. 2 shows particular steps for a process of notifying a service provider regarding Wi-Fi gateway issues, other examples of the process may add, omit, replace, repeat, and/or modify one or more steps.

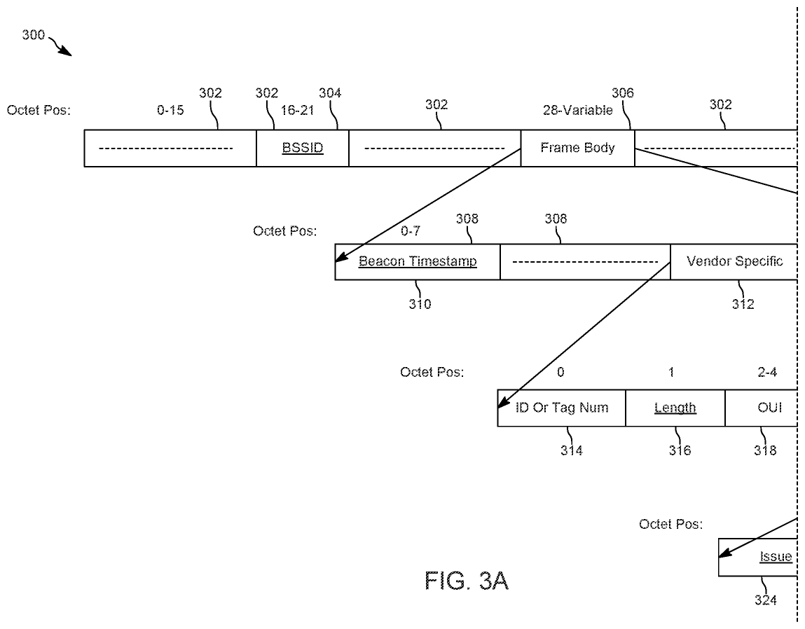

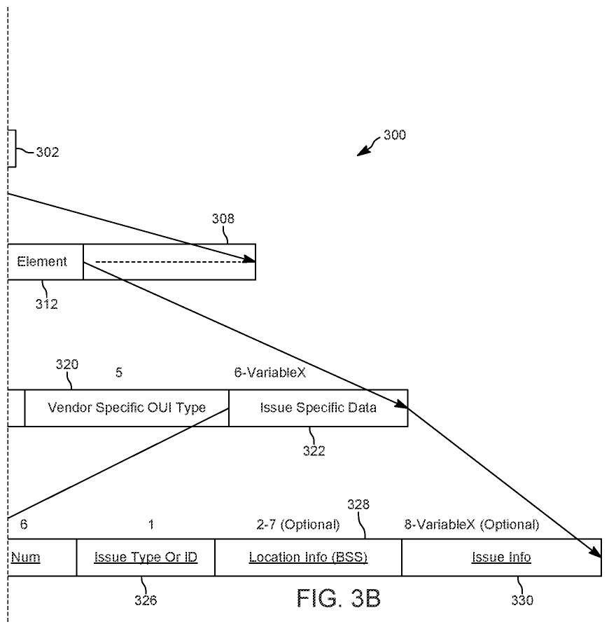

Referring to FIGS. 3A-3B, an example format of a beacon frame 300 that can receive embedded information regarding the Wi-Fi gateway issue is shown. The beacon frame may be 28 or more octets long having any suitable number of fields 302, which includes a Basic Service Set Identifier (BSSID) field 304 and a frame body 306. BSSID field 304 uniquely identifies each Basic Service Set (BSS) and indicates the Medium Access Control (MAC) address currently in use. Frame body 306 includes various fields 308, which includes a beacon timestamp 310 and a vendor specific element 312.

Vendor specific element 312 includes an ID or tag number field 314, a length field 316, an Organizationally Unique Identifier (OUI) field 318, a vendor specific OUI type field 320, and an issue specific data field 322. The vendor specific OUI type field may include a flag that indicates a detected issue with the Wi-Fi gateway. Issue specific data field 322 can receive unencrypted (plain) or encrypted data or information. In the example shown in FIG. 3, issue specific data field 322 includes an issue number field 324, an issue type of identification field 326, a location information field 328, and an issue information field 330. The issue specific data field includes a unique issue identifier generated by the Wi-Fi gateway. Location information field 328 includes location details for the BSS. In some embodiments, BSSID field 304 may alternatively, or additionally, include the location details. Issue information field 330 includes details of the issue when needed. Although particular fields are shown for beacon frame 300, other embodiments of beacon frame 300 may add, omit, replace, repeat, and/or modify one or more fields. Additionally, although particular octet positions are shown for each field, other examples of beacon frame 300 may include one or more fields with different octet positions.

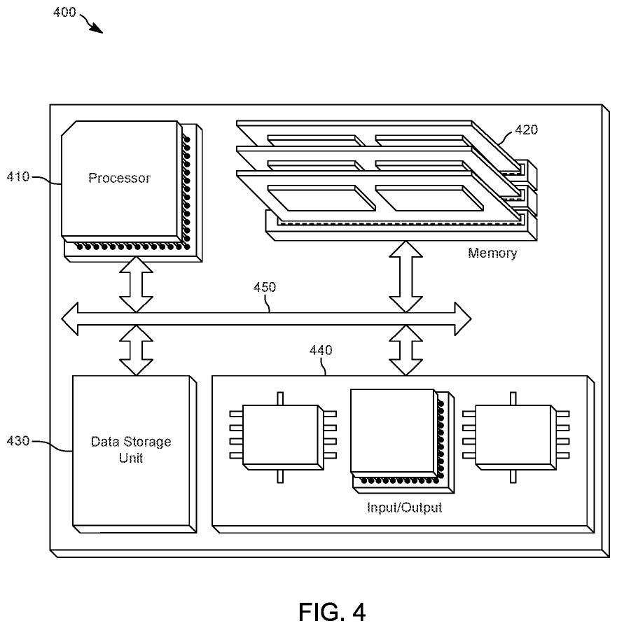

Referring to FIG. 4, a hardware configuration 400 operable to facilitate automatically updating stored content is shown. The hardware configuration may be configured to implement or execute one or more of the processes performed by any of the various components, engines, modules, and devices described in the present disclosure, including Wi-Fi gateway 104 and Wi-Fi device 106. The hardware configuration 400 may include a processor 410, a memory 420, a storage device 430, and an input/output device 440. Each of the components 410, 420, 430, and 440 may, for example, be interconnected using a system bus 450. The processor 410 may be capable of processing instructions for execution within the hardware configuration 400. In one implementation, the processor 410 may be a single-threaded processor. In another implementation, the processor 410 may be a multi-threaded processor. The processor 410 may be capable of processing instructions stored in the memory 420 or on the storage device 430.

The memory 420 may store information within the hardware configuration 400. In one implementation, the memory 420 may be a computer-readable medium. In one implementation, the memory 420 may be a volatile memory unit. In another implementation, the memory 420 may be a non-volatile memory unit. In some implementations, the storage device 430 may be capable of providing mass storage for the hardware configuration 400. In one implementation, the storage device 430 may be a computer-readable medium. In various different implementations, the storage device 430 may, for example, include a hard disk device, an optical disk device, flash memory or some other large capacity storage device. In other implementations, the storage device 430 may be a device external to the hardware configuration 400.

The input/output device 440 provides input/output operations for the hardware configuration 400. In embodiments, the input/output device 440 may include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a CPE device, IP device, mobile device, or other device. In embodiments, the input/output device may include driver devices configured to send communications to, and receive communications from an advertisement decision system, an advertisement media source, and/or a CDN.

The subject matter of this disclosure, and components thereof, may be realized by instructions that upon execution cause one or more processing devices to carry out the processes and functions described above. Such instructions may, for example, comprise interpreted instructions, such as script instructions, e.g., JavaScript or ECMAScript instructions, or executable code, or other instructions stored in a computer readable medium.

Implementations of the subject matter and the functional operations described in this specification may be provided in digital electronic circuitry, or in computer software, firmware, or hardware, including the structures disclosed in this specification and their structural equivalents, or in combinations of one or more of them. Embodiments of the subject matter described in this specification may be implemented as one or more computer program products, i.e., one or more modules of computer program instructions encoded on a tangible program carrier for execution by, or to control the operation of, data processing apparatus.

A computer program (also known as a program, software, software application, script, or code) may be written in any form of programming language, including compiled or interpreted languages, or declarative or procedural languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a mark-up language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows may also be performed by, and apparatus may also be implemented as, special purpose logic circuitry, e.g., an FPGA (field programmable gate array) or an ASIC (application specific integrated circuit).

Computer readable media suitable for storing computer program instructions and data include all forms of non-volatile memory, media, and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory may be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter described in this specification have been described. Other embodiments are within the scope of the following claims. For example, the actions recited in the claims may be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of notifying a service provider regarding Wi-Fi gateway issues, comprising:
detecting, via a Wi-Fi gateway, an issue related to the Wi-Fi gateway;
embedding, via the Wi-Fi gateway, information related to the detected issue in an IEEE 802.11 management frame;
broadcasting, via the Wi-Fi gateway, the IEEE 802.11 management frame with the embedded information;
receiving, via an application running on a Wi-Fi device, the IEEE 802.11 management frame with the embedded information; and
transmitting, via the application running on the Wi-Fi device, the embedded information to the service provider.

2. The method of claim 1, further comprising notifying, via the application running on the Wi-Fi device, a user associated with the Wi-Fi gateway.

3. The method of claim 1, further comprising storing, via the application running on the Wi-Fi device, the embedded information.

4. The method of claim 1, wherein embedding information related to the detected issue in an IEEE 802.11 management frame includes:
encrypting, via the Wi-Fi gateway, the information related to the detected issue; and
embedding, via the Wi-Fi gateway, the encrypted information related to the detected issue in the IEEE 802.11 management frame.

5. The method of claim 1, wherein transmitting the embedded information to the service provider includes extracting, via the application running on the Wi-Fi device, the embedded information from the received IEEE 802.11 management frame.

6. The method of claim 1, wherein extracting the embedded information from the received IEEE 802.11 management frame includes:
determining, via the application running on the Wi-Fi device, the received IEEE 802.11 management frame is from the Wi-Fi gateway; and
extracting, via the application running on the Wi-Fi device, the embedded information from the received IEEE 802.11 management frame only when the received IEEE 802.11 management frame is from the Wi-Fi gateway.

7. The method of claim 1, wherein the IEEE 802.11 management frame is a beacon frame.

8. The method of claim 1, wherein the Wi-Fi device is connected to the Wi-Fi gateway.

9. The method of claim 8, wherein transmitting the embedded information to the service provider is via an access point different from the Wi-Fi gateway.

10. The method of claim 8, wherein transmitting the embedded information to the service provider includes transmitting, via the application running on the Wi-Fi device, one or more cellular signals containing the embedded information to the service provider.

11. The method of claim 1, wherein the Wi-Fi device is not connected to the Wi-Fi gateway.

12. The method of claim 11, wherein transmitting the embedded information to the service provider is via an access point different from the Wi-Fi gateway.

13. The method of claim 11, wherein transmitting the embedded information to the service provider includes transmitting, via the application running on the Wi-Fi device, one or more cellular signals containing the embedded information to the service provider.

14. The method of claim 1, wherein detecting an issue related to the Wi-Fi gateway includes detecting, via the Wi-Fi gateway, a connectivity issue that prevents the Wi-Fi gateway from directly communicating with the service provider.
